(19) United States
(12) Patent Application Publication
(10) Pub. No.: US 2017/0344449 A1
(43) Pub. Date: Nov. 30, 2017

(54) TESTING METHOD OF ELECTRONIC DEVICES

(71) Applicant: WISTRON CORP., New Taipei City (TW)

(72) Inventors: Chien-Hsiang TUNG, New Taipei City (TW); Chung-Heng HAN, New Taipei City (TW); Ai-Ni LEE, New Taipei City (TW); Yi-Shiou HUANG, New Taipei City (TW); Po-Wei WANG, New Taipei City (TW)

(73) Assignee: WISTRON CORP., New Taipei City (TW)

(21) Appl. No.: 15/253,839

(22) Filed: Aug. 31, 2016

(30) Foreign Application Priority Data
May 27, 2016 (TW) 105116763

(51) Int. Cl. G06F 11/263; G06F 11/22

(52) U.S. Cl. CPC G06F 11/263; G06F 11/2236

(57) ABSTRACT

A testing method of electronic devices, each of which includes a central processing unit (CPU) for running an operating system (OS), includes the following steps when testing one of the electronic devices. The specification of the CPU of the electronic device and the version of the OS run on the CPU are identified. A test script of the electronic device is searched from a script lookup table according to the specification of the CPU and the version of the OS. The script lookup table records a variety of test scripts related to the specification of a variety of CPUs of a variety of electronic devices in combination with the version of a variety of operating systems. The found test script is provided to a testing module. The electronic device is tested by the testing module according to the found test script.

### CROSS-REFERENCE TO RELATED APPLICATIONS

This non-provisional application claims priority under 35 U.S.C. §119(a) on Patent Application No(s). 105116763 filed in Taiwan, R.O.C. on May 27, 2016, the entire contents of which are hereby incorporated by reference.

### TECHNICAL FIELD

The disclosure relates to a testing method of electronic devices, more particularly to a method of selecting a proper test script with respect to the specification of the central processing unit of each electronic device and the version of the operating system (OS) run on the central processing unit.

### RELATED ART

Electronic devices, e.g. smart phones, tablet computers or other suitable electronic devices, are usually subjected to a variety of tests with respect to device functions and the operations of their operating systems after manufacture, so as to assure that these electronic devices will normally execute application programs or perform other functions. With the proceeding advance of the categories, brands, models of electronic devices, the OS run on an electronic device is also updated again and again. An open-source OS, e.g. Android OS, provides a basic framework for the design of various operating systems, but system developers still need develop a variety of operating systems for a variety of models of electronic devices according to the specification of the electronic device. Therefore, each model of electronic devices and the OS run on the electronic device should be tested.

However, a complete test procedure includes the setting of device configurations and the time of the execution of function tests and typically takes a very long time, so it is not suitable to artificially execute this test procedure. Moreover, for example, the developer of the Android OS, Google Inc., also provides device authentications, e.g. the compatibility test suite (CTS) and the Google mobile service (GMS), to an electronic device using an Android OS as a built-in OS. When an electronic device passes the test of each test item for the CTS authentication and the GMS authentication, this electronic device is qualified to be an authenticated device that is authorized by the Google Inc. to pre-store a Google application program. In other words, to obtain the CTS authentication and the GMS authentication, the electronic device and the OS run thereon may need to repeatedly be tested and calibrated.

### SUMMARY

According to one or more embodiments, the disclosure provides a testing method for testing electronic devices. Each of the electronic devices includes a central processing unit for operating an OS. When testing one electronic device, the testing method includes the following steps. The specification of the central processing unit of the electronic device is identified, and the version of the OS run on the electronic device is identified. According to the specification of the central processing unit and the version of the OS, a test script related to the electronic device is looked up in a script lookup table which records the test script S, each of which corresponds to the specification of one of the central processing units in combination with the version of one of the operating systems. The test script found for the electronic device is provided to the test module. The electronic device is tested according to the test script by the test module.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flow chart of a testing method according to an embodiment of the disclosure; and

FIG. 2 is a flow chart of a testing method according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

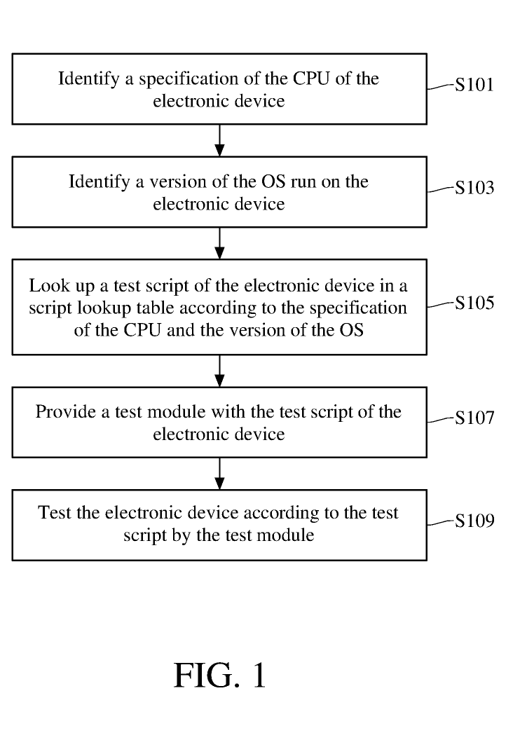

Please refer to FIG. 1. FIG. 1 is a flow chart of a testing method according to an embodiment of the disclosure. As shown in FIG. 1, the testing method is used to test electronic devices. To test electronic devices is, for example, to execute a test procedure onto all the electronic devices at the same time or to execute a batch test procedure onto one or more of the electronic devices every time, but the disclosure is not limited thereto. For example, electronic devices include smart phones, tablet computers or other suitable devices, and each of the electronic devices includes a central processing unit (CPU), which is used to operate an OS. In this embodiment, the central processing units of the electronic devices are not limited to have the same specification or different specifications, and the operating systems of the central processing units are not limited to belong to the same version or different versions. As an example, an electronic device D1 is disposed with a central processing unit C1 that operates an OS A1, an electronic device D2 is disposed with a central processing unit C1 that is the same as the central processing unit C1 of the electronic device D1 but operates an OS A2 different from the OS A1.

To a concise description, hereafter a processing module and a test module are exemplarily used to carry out the above testing method. In practice, the processing module is carried out by a computer system capable of executing data processing, and the test module is carried out by another computer system capable of executing one or more test procedures. Alternatively, the processing module and the test module are two computing blocks of a computer system for data processing and one or more test procedures, respectively. This embodiment is not limited to the implementations of the processing module and the test module. When a test procedure is executed onto all the electronic devices at the same time, one processing module is used to process data and more than one test module is used to test the electronic devices; alternatively, a computer system having a processing module and a test module is used to test one electronic device; and this embodiment is not limited to these implementations.

During the test of an electronic device, the processing module identifies the specification of the central processing unit of the electronic device as shown in step S101. In this embodiment, the specification of the central processing unit of the electronic device includes the model or type of the central processing unit of the electronic device or other indexes sufficient to distinguish one central processing unit from another central processing unit. In practice, the specification of a central processing unit is related to the processing ability of the central processing unit, the encoding ability and decoding ability of the central processing unit, or the ability of controlling one or more sensors, one or more panels or other components in the electronic device. As an example, the manner for the processing module to identify the specification of a central processing unit of an electronic device is the artificial input of the model of the central processing unit, the verification of an image capturing device to the image of the central processing unit, the determination of the readings of built-in system data of the electronic device, or other suitable manners, and this embodiment is not limited thereto.

In step S103, the processing module identifies the version of the OS run on the electronic device. In the case of the Android OS, the version of the OS is the version of the infrastructure version of an electronic device, e.g. Android 6.0, Android 5.5, Android 5.0 and so on. Alternatively, the version of an OS is the version of the OS related to a model of electronic devices. Practically, since a different model of electronic devices has its own central processing unit, one or more sensors, one or more panels or other components, the OS run on a different model of electronic devices is constructed based on Android 6.0, Android 5.5 or Android 5.0. In other words, identifying the version of an OS run on an electronic device is related to the compatibility between the OS and the inner components of the electronic device, whether a central processing unit of the electronic device can normally run the OS, or whether instructions of the OS can command the electronic device to do related actions. For example, the manner for the processing module to identify the version of an OS run on an electronic device is the artificial input of the version of the OS, the verification of an image capturing device to display images of the electronic device, the determination of the readings of built-in system data of the electronic device, or other suitable manners, and this embodiment is not limited thereto.

Then, in step S105, according to the specification of the central processing unit and the version of the OS, a test script is looked up in a script lookup table for the electronic device. The script lookup table records test script S each corresponding to the specification of one of the central processing units in combination with the version of one of the operating systems. For example, indexes of a script lookup table are respectively combinations of the specification of a central processing unit and the version of an OS, such as the combination of one central processing unit C1 and one OS A1, the combination of one central processing unit C1 and one OS A2, the combination of one central processing unit C2 and one OS A1, and the combination of one central processing unit C2 and one OS A2, and each index corresponds to a test script. For example, to test the electronic device D1, a test script Scr1 corresponding to the combination of the central processing unit C1 and the OS A1 can be found in the script lookup table according to the central processing unit C1 of the electronic device D1 and the OS A1.

In step S107, the test script related to the electronic device is provided to the test module so that the test module can test the electronic device (i.e. perform a related test procedure) according to the test script. Such a test script includes commanding the test module to install an application program onto the electronic device, setting a device configuration, executing the test of test items, sending out a test result, organizing test results or other suitable test procedures. A test script integrates instructions, test tools or program languages together and permits the test module to perform a sequence of test procedures indicated by the content of the test script to the electronic device after test module is enabled to execute the test script.

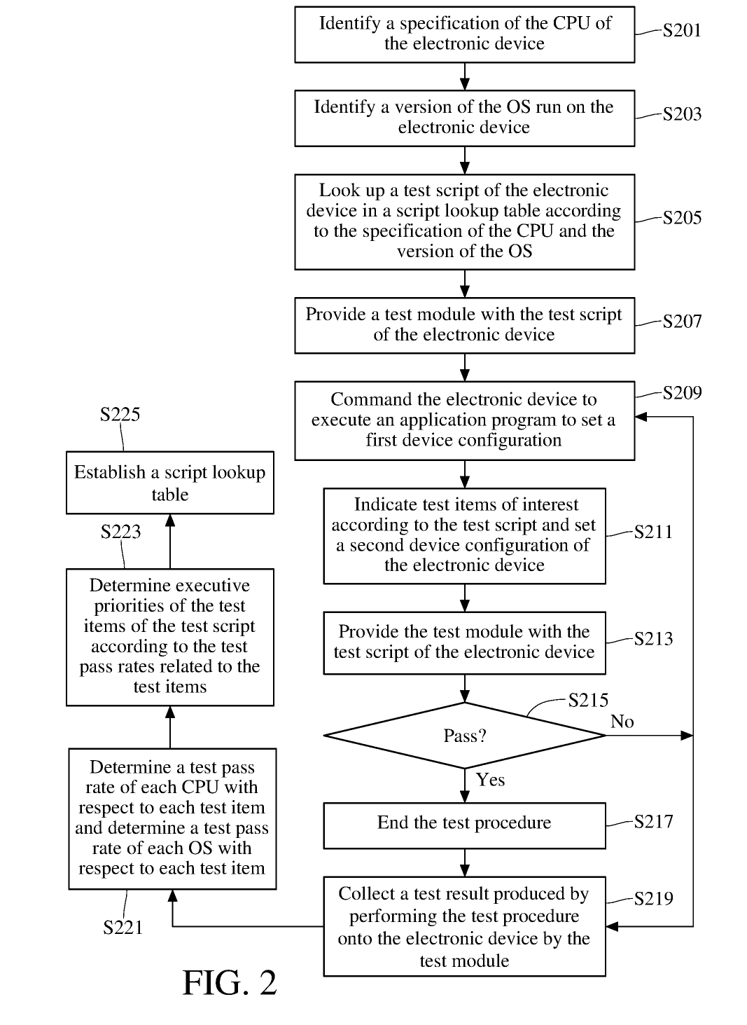

Please refer to FIG. 2. FIG. 2 is a flow chart of a testing method according to another embodiment of the disclosure. As shown in FIG. 2, this testing method is one or more test procedures to test electronic devices, such as smart phones, tablet computers, or other suitable devices. Each electronic device includes a central processing unit for running an OS.

For concise descriptions hereafter, Table 1 is used to exemplify the specifications of central processing units of electronic devices and the versions of operating systems run on the central processing units.

TABLE 1

Electronic device

| | D1 | D2 | D3 | D4 | D5 | D6 | D7 | D8 |
|---|---|---|---|---|---|---|---|---|
| CPU | C1 | C1 | C1 | C2 | C2 | C2 | C3 | C3 |
| OS | A1 | A2 | A3 | A1 | A2 | A3 | A1 | A2 |

In an exemplary case of testing the electronic device D1, the processing module identifies that specification of the central processing unit of the electronic device D1 is C1 in step S201; in step S203, the processing module identifies that the version of the OS run on the electronic device D1 is A1; in step S205, the processing module, according to the specification of the central processing unit and the version of the OS, finds out a test script Scr1 related to the electronic device D1 in the script lookup table; in step S207, the processing module provides the test module with the test script Scr1 so that the test module can perform a test procedure to test the electronic device D1 according to the test script Scr1.

During the test procedure, the test module commands the electronic device to execute an application program according to the test script Scr1 to set the first device configuration of the electronic device D1 in step S209 and set the second device configuration of the electronic device D1 in step S211. In other words, before it is started to test the electronic device, the device configuration of the electronic device should be set according to the requirement of each test item. For example, setting the device configuration of the electronic device includes enabling one or more communication components of the electronic device, linking the enabled communication component of the electronic device to a wireless access point, adjusting the screen brightness of the electronic device, adjusting the time zone of the electronic device, setting the domain name system (DNS) of the electronic device, unlocking the screen of the electronic device, avoiding switching to the sleep mode of the electronic device, enabling the linking of the connection interface, e.g. the USB, of the electronic device, setting the security configuration of the electronic device, or other suitable preceding settings, but this embodiment is not limited thereto.

In this embodiment, the test module executes an application program to set the first device configuration of the electronic device and directly executes the test script to set the second device configuration of the electronic device so that a part of the device configurations, which cannot be set by the application program, can be set according to the test script by the test module as another part of the device configurations, which cannot be set by the test module, can be set by the application program. Setting the device configuration of the electronic device via an application program may enhance the efficiency of the preceding settings and permit testing personnel to input some information, e.g. the account and password of a wireless assess point or other information, into the application program. In an embodiment, the application program is constituted by, for example, the Android application package (APK) so that the application program has the security protection of code signing.

In practice, for example, the first device configuration, which the test module sets via the application program, is enabling one or more communication components of the electronic device, linking the communication component of the electronic device to a wireless access point, adjusting the screen brightness of the electronic device, adjusting the time zone of the electronic device, setting the domain name system (DNS) of the electronic device or other suitable preceding settings. Setting the second device configuration via the test script is, for example, unlocking the screen of the electronic device, avoiding entering the sleep mode of the electronic device, enabling the linking of the connection interface, e.g. the USB, of the electronic device, setting the security configuration of the electronic device or other suitable preceding settings. For example, a test script employs coordinate operating commands, graphical operating commands, objected-oriented operating commands or a combination thereof to set the device configuration of an electronic device, but this embodiment is not limited thereto. The coordinate operating command is triggered by, for example, one or more coordinate positions on a touch screen, so the test module sets the configuration of the electronic device according to the coordinate position on the touch screen. The graphical operating command is triggered by, for example, capturing and compare the image of the display screen of the electronic device to find a correctly-matched position in the image, and at this position, a robotic arm or other suitable apparatus is used to set the electronic device. The objected-oriented operating command works in coordination with, for example, the source object compiling and the source program transform to set the electronic device.

Then, after the configurations of the electronic device D1 are set, the test module starts testing the electronic device D1 according to one or more test items indicated by the test script in step S213. As an example, the one or more test items indicated by the test script include the test of the performance of one or more wireless communication components, the test of the encoding and decoding functions of the central processing unit, the test of the camera function, the test of clock rate, the test of hardware, the test of networking, the test of data security, the test to the position sensor, the test of playing image streams, the test of the scheduling ability, or other suitable test items. In another embodiment, the test items are test items which an electronic device is required by, for example, the Android OS developer, Google Inc. to pass for the CTS and GMS authentications.

In step S215, the test module determines whether the electronic device D1 passes all the test items, and in step S217, the test procedure ends. In step S219, the test module collects the test result of the electronic device D1.

In the case of the test items required in the CTS and GMS authentications, the test module determines whether an electronic device passes the test of each test item. When the electronic device does not pass the test of one of the test items, the test module returns to step S209 to test the electronic device again. In the embodiment of passing the CTS and GMS authentications, Google Inc. may require that an electronic device should be tested twice. After the electronic device is tested for the second time, if there is still a part of the test items that the electronic device does not pass in step S215, the test module will execute step S217 to end the test procedure. In another embodiment, the test module still ends the test procedure even though the electronic device does not pass all the test items, and the test module may end the test procedure after testing the electronic device once, and collects the test result indicating whether the electronic device passes each test item during the test procedure.

In an embodiment, when the electronic device executes one of the test items, the test module would monitor the electronic device and according to whether the electronic device generates a designated feature code, determine whether the electronic device passes this test item. For example, the test module monitors the source object compiled code running on the electronic device or employs an image capturing device to monitor the display screen of the electronic device. For example, when the test module monitors the source object compiled code running on the electronic device, the source object compiled code running on the electronic device would be continuously updated, and when the electronic device finishes the test item, updating the source object compiled code would be suspended. In the case of monitoring the source object compiled code running on the electronic device, the test module, according to the updating of the source object compiled code running on the electronic device, determines whether the electronic device generates any designated feature code, and when the electronic device generates a designated feature code, the test module considers that the electronic device passes the test.

In another case of employing an image capturing device to monitor the display screen of the electronic device, when the electronic device subjected to, for example, the test of playing image streams finishes the play of an image stream, the display screen of the electronic device would show a picture or text to present the completion of play so that the test module could consider this picture or text as a designated feature code and then confirm that the electronic device passes this test item; and however, when the electronic device does not show any picture or text to present the completion of play, the test module would determine that the electronic device does not pass this test item. In practice, there is a time limit for every test item to which the electronic device will be subjected; and if in an example, a related time limit is up and no designated feature code occurs to the display screen or the source object compiled code of the electronic device has not, the test module also determines that the electronic device does not pass this test item.

After the test module finishes the test procedure done onto the electronic device, the test module can perform file format conversion, information filtering or other suitable data organizations onto the test result of the electronic device and then email it to testing personnel or store it into a database or upload it to the authentication server provided by Google Inc.

In step S221, the test module sends the test result of the electronic device D1 to the processing module so that the processing module could commence analyzing the test result. In this embodiment, the processing module collects the test result of each electronic device from the test module to determine the test pass rate of the specification of each central processing unit with respect to each test item and the test pass rate of the version of each OS with respect to each test item according to all the collected test results.

As an example, the test module has executed a test procedure onto one or more electronic devices D1 by the test script Scr1 for 10 times, a test procedure onto one or more electronic devices D2, D5 and D8 by the test script Scr2 for 10 times, a test procedure onto one or more electronic devices D3 and D6 by the test script Scr3 for 10 times, and a test procedure onto one or more electronic devices D4 and D7 by the test script Scr4 for 10 times, as shown in Table 2 below. For example, executing a test procedure onto one or more electronic devices D1 by the test script Scr1 for 10 times is testing the same electronic device D1 for 10 times or is testing the electronic devices D1 for a total of 10 times.

TABLE 2

| | Electronic device | | | | | | | |
|---|---|---|---|---|---|---|---|---|
| | D1 | D2 | D3 | D4 | D5 | D6 | D7 | D8 |
| CPU | C1 | C1 | C1 | C2 | C2 | C2 | C3 | C3 |
| OS | A1 | A2 | A3 | A1 | A2 | A3 | A1 | A2 |
| Test script | Scr1 | Scr2 | Scr3 | Scr4 | Scr5 | Scr6 | Scr7 | Scr8 |
| The number of | 10 | 10 | 10 | 10 | 10 | 10 | 10 | 10 |
| times | | | | | | | | |

Test items in each test script are exemplarily listed in Table 3.

TABLE 3

| Test script | Scr1 | Scr2 | Scr3 | Scr4 | Scr5 | Scr6 | Scr7 | Scr8 |
|---|---|---|---|---|---|---|---|---|
| Test item Test1 | ✓ | ✓ | ✓ | ✓ | ✓ | ✓ | ✓ | ✓ |
| Test item Test2 | ✓ | ✓ | ✓ | ✓ | ✓ | ✓ | ✓ | ✓ |
| Test item Test3 | ✓ | — | ✓ | ✓ | — | ✓ | ✓ | — |
| Test item Test4 | — | ✓ | ✓ | — | ✓ | ✓ | — | ✓ |

The processing module collects all test results, which are exemplified by Table 4, where the electronic device D1 does not pass the test item Test1 for 5 times and the test item Test2 once, and the others can be deduced by analogy.

TABLE 4

| | Electronic device | | | | | | | |
|---|---|---|---|---|---|---|---|---|
| | D1 | D2 | D3 | D4 | D5 | D6 | D7 | D8 |
| Test item Test1 | 5 | 2 | 4 | 2 | 1 | 4 | 2 | 1 |
| Test item Test2 | 1 | 3 | 1 | 1 | 2 | 1 | 1 | 5 |
| Test item Test3 | 0 | — | 0 | 0 | — | 0 | 0 | — |
| Test item Test4 | — | 1 | 1 | — | 0 | 1 | — | 0 |

The processing module, according to all the collected test results, determines the test pass rate of the specification of each central processing unit for each test item, as shown in Table 5. For the central processing unit C1, all the electronic devices D1˜D3 are disposed with the central processing unit C1, the electronic devices D1˜D3 are subjected to the test of the test item Test1 for a total of 30 times, the electronic device D1 does not pass the test for 5 times, the electronic device D2 does not pass the test for 2 times, the electronic device D3 does not pass the test for 4 times, and the number of times of fails is totally 11, so the test pass rate of the central processing unit C1 is 63% (i.e. (30−11)/30=63). The test pass rates of the other central processing units can be deduced by analogy.

TABLE 5

| CPU | C1 | C2 | C3 |
|---|---|---|---|
| Test item Test1 | 63% | 76% | 85% |
| Test item Test2 | 83% | 87% | 70% |
| Test item Test3 | 100% | 100% | 100% |
| Test item Test4 | 90% | 95% | 100% |

Likewise, the processing module, according to all the collected test results, determines the test pass rate of the version of each OS for each test item, as shown in Table 6. For the OS A1, all the electronic devices D1, D4 and D7 run the OS A1, the electronic devices D1, D4 and D7 are subjected to the test of the test item Test1 for a total of 30 times, the electronic device D1 fails for 5 times, the electronic device D4 fails for 2 times, the electronic device D7 fails for 2 times, and the number of fails totals to 9 times, so the test pass rate of the OS A1 is 70% (i.e. (30−9)/30=70). The test pass rates of the other operating systems can be deduced by analogy.

TABLE 6

| OS | A1 | A2 | A3 |
|---|---|---|---|
| Test item Test1 | 70% | 87% | 73% |
| Test item Test2 | 90% | 67% | 93% |
| Test item Test3 | 100% | — | 100% |
| Test item Test4 | — | 97% | 93% |

In step S223, the processing module, according to the test pass rate of each central processing unit and the test pass rate of each OS, determines the executive priority of each test item indicated by each test script. For example, when there is a new electronic device D9 including the central processing unit C3 running the OS A3, the processing module would decide the executive priorities of the test items of the test script related to the electronic device D9 according to the 85% test pass rate of the central processing unit C3 against the test item Test1, the 73% test pass rate of the OS A3 against the test item Test1, the 70% test pass rate of the central processing unit C3 against the test item Test2, the 93% test pass rate of the OS A3 against the test item Test2, the 100% test pass rate of the central processing unit C3 against the test item Test3, the 100% test pass rate of the OS A3 against the test item Test3, the 100% test pass rate of the central processing unit C3 against the test item Test4 and the 93% test pass rate of the OS A3 against the test item Test4. In this embodiment, a test item with a relatively low test pass rate has relatively-high priority. In other words, in this embodiment, since the central processing unit C3 and the OS A3 respectively have relatively low average test pass rates with respect to the test item Test1 than the other test items, the executive priorities of the test items indicated the test script related to the electronic device D9 are arranged as: the test item Test1, the test item Test2, the test item Test4, and the test item Test3.

In step S225, the processing module, according to the collected test results of the electronic devices, decides the executive priorities of the test items indicated by the test script, so as to establish a script lookup table. For example, the executive priorities of the test items indicated by the test script Scr9 related to the electronic device D9 are set as: the test item Test1, the test item Test2, the test item Test4, and the test item Test3.

In an embodiment, the processing module determines the executive priority of each test item in each test script according to the weighting rule between the central processing unit and the OS in combination with the test pass rate of each central processing unit as well as the test pass rate of each OS. As an example, if the weighting rule between the central processing unit and the OS is that the weight of the central processing unit is 1.5 times the weight of the OS, the foregoing electronic device D9 would have an average test pass rate of 80.2% (i.e. (85%×1.5+73%)/2.5=80.2%) with respect to the test of the test item Test1, and an average test pass rate of 79.2% (i.e. (70%×1.5+93%)/2.5=79.2%) with respect to the test of the test item Test2. In other words, in this embodiment, the executive priorities of the test items in the test script Scr9 are arranged as: the test item Test2, the test item Test1, the test item Test4 and the test item Test3.

In another embodiment, if there is a new electronic device D10 disposed with the central processing unit C3 running a new OS A4, the processing module does not learn about the test pass rate of the OS A4 for each test item since the test module has not executed any test procedure onto the OS A4 yet. Therefore, the processing module could search for any possible test pass rate of each test item related to the OS A4 in an external database, e.g. data on the Internet or other suitable data sources, and use the found data in combination with the presently collected test results to determine the executive priority of each test item in the test script Scr10 related to the electronic device D10.

In practice, when constructing the test script for each electronic device, the processing module would select one or more test items in the test script according to the version of the OS and then determine the executive priority of each test item in each test script according to the test pass rate of each central processing unit and the test pass rate of each OS, but the disclosure is not limited thereto.

In view of the foregoing example, the electronic devices D1˜D10, the central processing units and the operating systems are only for a concise description, and the foregoing number of times of test, the foregoing the number of fails in test, the foregoing test pass rate and the foregoing weighting rule are only for a concise description. A person of ordinary skill in the art should understand that the foregoing descriptions are concise, and in practice, the processing module and the test module can respectively deal with a large number of test procedures and a large number of test results so that the processing module can provide the test module with more proper test scripts for testing electronic devices.

In an embodiment, the processing module further updates the executive priority of each test item in each test script according to the collected test results after collecting a preset amount of test results. In this way, the test module continuously reports each test result, obtained by testing each electronic device, to the processing module so that the processing module can update each test script according to the test results to enhance the efficiency of the test procedure.

In summary, the disclosure provides a testing method of electronic devices to identify the specification of the central processing unit of each electronic device and the version of the operating system of each electronic device, so the test module can select proper test scripts for these electronic devices to test the electronic devices, so as to reduce the waste of labor cost during the test procedure and enhance the test efficiency. In an embodiment, the test script would first execute the test of the test item with a relatively low test pass rate, so the test module and testing personnel could earlier discover the problem existing in the electronic device under test and try to resolve the discovered problem during the test procedure, so as to earn a longer time for resolving the problem before the next test procedure and enhance the efficient use of human resources. In the exemplary cases of the CTS and GMS authentications, the testing method in the disclosure could enhance the efficiency that electronic devices obtain authentication, so that these electronic devices could provide more functional services.

What is claimed is:

1. A testing method for testing electronic devices, each of the electronic devices including a central processing unit for performing an operating system, and when testing one of the electronic devices, the testing method comprising:
identifying a specification of the central processing unit of the electronic device;
identifying a version of the operating system run on the electronic device;
looking up a test script of the electronic device in a script lookup table according to the specification of the central processing unit and the version of the operating system, and the script lookup table recording a variety of test scripts corresponding to the specification of a variety of central processing units in combination with the version of a variety of operating systems;
providing a test module with the test script of the electronic device; and
testing the electronic device according to the test script by the test module.

2. The testing method according to claim 1, wherein testing the electronic device according to the test script by the test module comprises:
commanding the electronic device to execute an application program to set a first device configuration;
indicating test items of interest according to the test script, and setting a second device configuration of the electronic device; and
executing tests of the test items onto the electronic device after the first device configuration and the second device configuration of the electronic device have been set.

3. The testing method according to claim 2, wherein when the electronic device execute the test of one of the test items, the test module monitors the electronic device; and the test module determines that the electronic device passes the test of the test item, in response to a designated feature code generated by the electronic device when the test of the test item executed onto the electronic device is finished.

4. The testing method according to claim 3, wherein when the electronic device does not pass the test of one of the test items in the test script, the test module further tests the electronic device again according to the test script.

5. The testing method according to claim 2, further comprising:
collecting a test result of the electronic device in accordance with the test script by the test module, and the test result including whether the electronic device passes the test of each of the test items in the test script.

6. The testing method according to claim 5, further comprising:
sending the test result to a processing module by the test module;
collecting the test results of the electronic devices by the processing module;
according to the test results, determining a test pass rate of the specification of each of the central processing units with respect to each of the test items and determining a test pass rate of the version of each of the operating systems with respect to each of the test items by the processing module;
determining the test scripts, each of which corresponds to the specification of one of the central processing units in combination with the version of one of the operating systems, according to the test pass rates of the central processing units and the test pass rates of the operating systems by the processing module.

7. The testing method according to claim 6, wherein the processing module further collects test information from an external database and determines the test scripts, each of which corresponds to the specification of one of the central processing units in combination with the version of one of the operating systems, according to the test information.

8. The testing method according to claim 6, wherein the processing module selects the test items of each of the test scripts according to each of the operating systems and determines executive priorities of the selected test items of each of the test scripts according to the test pass rate of each of the central processing units and the test pass rate of each of the operating systems.

9. The testing method according to claim 8, wherein the processing module further determines the executive priorities of the test items of each of the test scripts according to a weighting rule between each of the central processing units and each of the operating systems.

10. The testing method according to claim 8, wherein when an amount of test results collected by the processing module is up to a preset value, the processing module updates the executive priorities of the test items of each of the test scripts according to the collected test results.
